(19) United States
(12) Patent Application Publication
(10) Pub. No.: US 2023/0199231 A1
(43) Pub. Date: Jun. 22, 2023

(54) VIRTUAL VENUE

(71) Applicants: Benoit Fredette, Monaco (MC); Venkata Ganesan, Brooklyn, NY (US)

(72) Inventors: Benoit Fredette, Monaco (MC); Venkata Ganesan, Brooklyn, NY (US)

(21) Appl. No.: 17/996,234

(22) PCT Filed: Apr. 19, 2021
(86) PCT No.: PCT/CA2021/050529

§ 371 Date: Oct. 14, 2022

Related U.S. Application Data
(60) Provisional application No. 63/011,520, filed on Apr. 17, 2020.

(51) Int. Cl. H04N 21/2187; H04N 21/218; H04N 21/262; H04N 21/472; H04N 21/4788

(52) U.S. Cl. CPC H04N 21/2187; H04N 21/21805; H04N 21/2625; H04N 21/47202; H04N 21/4788

(57) ABSTRACT

One or more requests to access live multimedia content are received from a plurality of devices over a communication network. Based on the one or more requests, a first subset of the plurality of devices is provided access, over the communication network, to a stream comprising the live multimedia content, the stream generated by a plurality of cameras capturing a live event occurring in a physical location. A second subset of the plurality of devices is iteratively selected among the first subset of devices, a webcam feed signal of each device in the second subset of devices is caused to be rendered, in real-time, at a given position on a screen provided at he physical location, and, as a function of the given position, the second subset of devices is provided access, over the communication network, to a camera feed signal from a selected one of the plurality of cameras.

### CROSS REFERENCE TO RELATED APPLICATIONS

This patent application claims priority of U.S. provisional Application Ser. No. 63/011,520, filed on Apr. 17, 2020, the entire contents of which are hereby incorporated by reference.

### TECHNICAL FIELD

The present disclosure relates to the field of event admission, and more particularly to streaming live interactive events online.

### BACKGROUND OF THE ART

A number of platforms enable content providers to stream live events to users online. However, existing techniques are limited in terms of the interactions that are available for attendees, amongst themselves or with the content provider. Indeed, with conventional streaming techniques, the audience's reaction is generally not synchronized with the live event being streamed and users experience a time delay (also referred to as latency or lag) when viewing the live stream. In addition, the quality of the content viewed by users may vary depending on the configuration of the user devices, leading to reduced user satisfaction. There is therefore room for improvement.

### SUMMARY

In accordance with one aspect, a system comprising a memory, a processor, and an application stored in the memory and executable by the processor for receiving over a communication network, from a plurality of devices, one or more requests to access live multimedia content, providing, based on the one or more requests, a first subset of the plurality of devices access, over the communication network, to a stream comprising the live multimedia content, the stream generated by a plurality of cameras capturing a live event occurring in a physical location, and iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.

In some embodiments, for each device in the second subset of devices, the application is executable by the processor for causing audio and video signals generated by the device to be directed at a performer performing the live event in the physical location, the audio and video signals directed at the performer as a function of the given position.

In some embodiments, the application is executable by the processor for selecting at least one device among the second subset of devices, and for enabling, through the at least one device and the at least one screen, real-time interaction between a user of the at least one device and a performer performing the live event in the physical location.

In some embodiments, the application is executable by the processor for providing the second subset of devices access, over the communication network, to camera feed signals from other ones of the plurality of cameras.

In some embodiments, the application is executable by the processor for selecting, among the first subset of devices, a new subset of devices to become the second subset of devices.

In some embodiments, the application is executable by the processor for selecting the new subset of devices after a predetermined time period has elapsed.

In some embodiments, the application is executable by the processor for receiving the one or more requests comprising receiving in real-time, during a bidding procedure, one or more bids for acquiring access to the live multimedia content based on user-specific criteria, and for selecting the first subset of devices and the second subset of devices and providing access to the stream based on the one or more bids.

In some embodiments, the application is executable by the processor for causing at least one streaming server to introduce a pre-determined time delay into the stream and broadcast the stream having the pre-determined time delay to the first subset of devices over the communication network, and for causing the at least one streaming server to remove the pre-determined time delay from the stream and broadcast the stream in which the pre-determined time delay is removed to the second subset of devices over the communication network.

In some embodiments, the application is executable by the processor for causing the live multimedia content to be rendered on a graphical user interface presented on each device of the first subset of devices and of the second subset of devices, and for causing the webcam feed signal of each device in the second subset of devices to be rendered on the graphical user interface.

In some embodiments, the application is executable by the processor for transmitting to each device in the second subset of devices an invitation to share the webcam feed signal in real-time and for causing the webcam feed signal to be rendered at the given position on the screen and providing the second subset of devices access to the camera feed signal upon receiving an indication of acceptance of the invitation.

In accordance with another aspect, there is provided a computer-implemented method comprising, at a processor receiving over a communication network, from a plurality of devices, one or more requests to access live multimedia content, providing, based on the one or more requests, a first subset of the plurality of devices access, over the communication network, to a stream comprising the live multimedia content, the stream generated by a plurality of cameras capturing a live event occurring in a physical location, and iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.

In some embodiments, the method further comprises, for each device in the second subset of devices, causing audio and video signals generated by the device to be directed at a performer performing the live event in the physical location, the audio and video signals directed at the performer as a function of the given position.

In some embodiments, the method further comprises selecting at least one device among the second subset of devices, and enabling, through the at least one device and the at least one screen, real-time interaction between a user of the at least one device and a performer performing the live event in the physical location.

In some embodiments, the method further comprises providing the second subset of devices access, over the communication network, to camera feed signals from other ones of the plurality of cameras.

In some embodiments, the method further comprises selecting, among the first subset of devices, a new subset of devices to become the second subset of devices.

In some embodiments, the new subset of devices is selected after a predetermined time period has elapsed.

In some embodiments, receiving the one or more requests comprises receiving in real-time, during a bidding procedure, one or more bids for acquiring access to the live multimedia content based on user-specific criteria, the first subset of devices and the second subset of devices selected and access to the stream provided based on the one or more bids.

In some embodiments, the method further comprises causing at least one streaming server to introduce a pre-determined time delay into the stream and broadcast the stream having the pre-determined time delay to the first subset of devices over the communication network, and causing the at least one streaming server to remove the pre-determined time delay from the stream and broadcast the stream in which the pre-determined time delay is removed to the second subset of devices over the communication network.

In some embodiments, the method further comprises causing the live multimedia content to be rendered on a graphical user interface presented on each device of the first subset of devices and of the second subset of devices, and causing the webcam feed signal of each device in the second subset of devices to be rendered on the graphical user interface.

In some embodiments, the method further comprises transmitting to each device in the second subset of devices an invitation to share the webcam feed signal in real-time and causing the webcam feed signal to be rendered at the given position on the screen and providing the second subset of devices access to the camera feed signal upon receiving an indication of acceptance of the invitation.

In accordance with yet another aspect, there is provided a computer readable medium having stored thereon program code executable by a processor for receiving over a communication network, from a plurality of devices, one or more requests to access live multimedia content, providing, based on the one or more requests, a first subset of the plurality of devices access, over a communication network, to a stream comprising the live multimedia content, the stream generated by a plurality of cameras capturing a live event occurring in a physical location, and iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.

### BRIEF DESCRIPTION OF THE DRAWINGS

Further features and advantages of the present invention will become apparent from the following detailed description, taken in combination with the appended drawings, in which:

FIG. 1 is a schematic diagram of a system for streaming live multimedia content to an audience in a virtual venue, in accordance with an illustrative embodiment;

FIG. 2A is a schematic diagram of a broadcast studio associated with the content provider of FIG. 1, in accordance with an illustrative embodiment;

FIG. 2B is a schematic diagram illustrating the position of screens and cameras in the broadcast studio of FIG. 2A, in accordance with an illustrative embodiment;

FIG. 3A is a schematic diagram of a Graphical User Interface (GUI) presented on a client device of FIG. 1, in accordance with an illustrative embodiment;

FIG. 3B is a schematic diagram of a Graphical User Interface (GUI) presented on a client device of FIG. 1 when a user is featured live, in accordance with an illustrative embodiment;

FIG. 4 is a schematic diagram of an application running on the processor of FIG. 1;

FIG. 5 is a flowchart of a method for streaming live multimedia content to an audience in a virtual venue, in accordance with an illustrative embodiment;

FIG. 6 is a flowchart of the step of FIG. 5 of managing access to the virtual venue and the live content; and

FIG. 7 is a flowchart of the step of FIG. 6 of granting user(s) access to the virtual venue and to live content.

It will be noted that throughout the appended drawings, like features are identified by like reference numerals.

### DETAILED DESCRIPTION

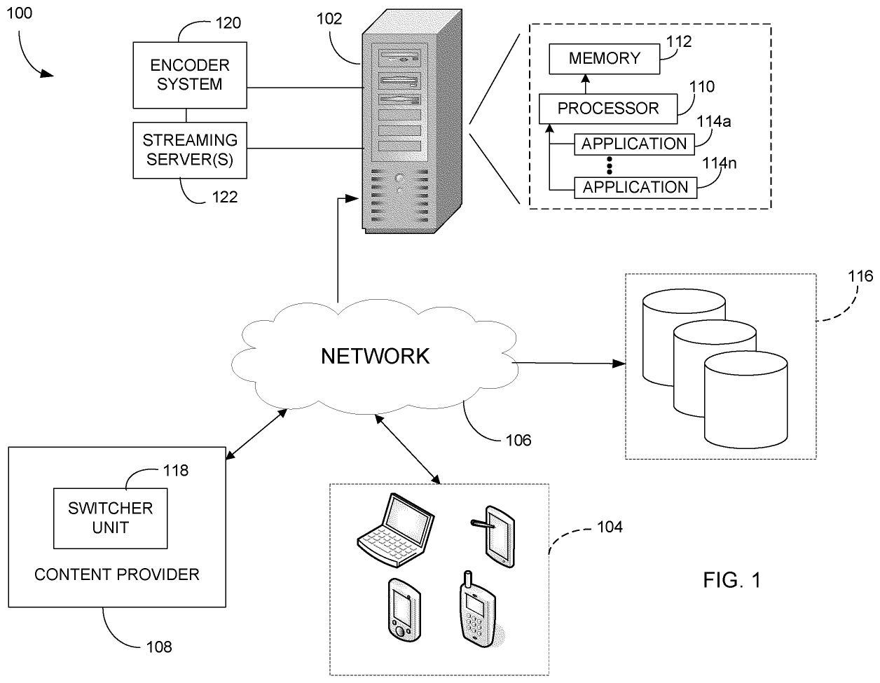

Referring to FIG. 1, a system 100 for streaming live multimedia content to an audience in a virtual venue will now be described, in accordance with one embodiment. As used herein, the term ‘streaming’ refers to the process of delivering multimedia content (i.e. content combining different forms, such as audio and video, into a single presentation) to end users in real-time and online (i.e. over the Internet). The media is simultaneously recorded and broadcast, as opposed to non-live media, such as video-on-demand and the like, which is not live-streamed. The illustrated system 100 comprises one or more server(s) 102 adapted to communicate with a plurality of client devices 104 via a network 106, such as the Internet, a cellular network, Wi-Fi, the Public Switch Telephone Network (PSTN), or others known to those skilled in the art.

As will be discussed further below, the client devices 104 allow members of an audience (referred to herein as ‘users’ or ‘attendees’) to gain access to a virtual venue and view live multimedia content broadcast (or streamed) by a content provider 108. The client devices 104 may comprise any device (whether mobile or not) configured to communicate over the network 106. Examples of the client devices 104 include, but are not limited to, laptop computers, desktop personal computers, handled personal computers or personal digital assistants (PDAs), tablet computers, smart televisions, and smartphones. The client devices 104 illustratively run a browsing program, such as Microsoft's Internet Explorer™, Mozilla Firefox™ Safari™, a Wireless Application Protocol (WAP) enabled browser in the case of a smart phone, or a native mobile application. The client devices 104 may also include one or more interface devices, such as a keyboard, a mouse, a touchscreen, a webcam, and the like (not shown), for interacting with a Graphical User Interface (GUI) presented on each device 104 when the user accesses the virtual venue.

The system 100 may be used to broadcast (or stream) the live multimedia content to a large audience (e.g., thousands of client devices 104). For this purpose, in one embodiment, audio and video signals from a live event (e.g., a live concert, or the like) are recorded (or captured) by a recording system, at an indoors physical location (e.g., in a broadcast studio or the like) or at an outdoors physical location (e.g., an entertainment venue such as a stadium/arena, a theater, a concert hall, or the like). The resulting multimedia content is broadcast in real-time to users by pushing the multimedia content into a virtual venue layer rendered on the client devices 104.

In one embodiment, a virtual environment may be created to represent the physical environment (e.g., the surroundings of the performer) in which the live event is recorded. Physical seats or spectators that would be present at a venue in the real world may also be virtually recreated. The virtual venue may therefore be a virtual or digital (two- or three-dimensional) representation of the physical counterparts of a real venue and the virtual venue layer may be a fictive or digital layer that is generated to reflect the user's field of view within the virtual environment.

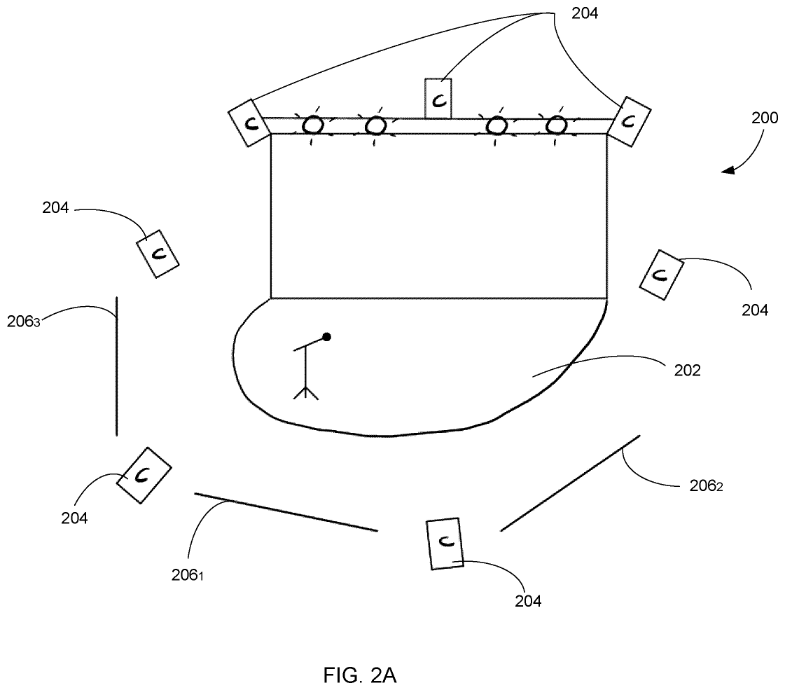

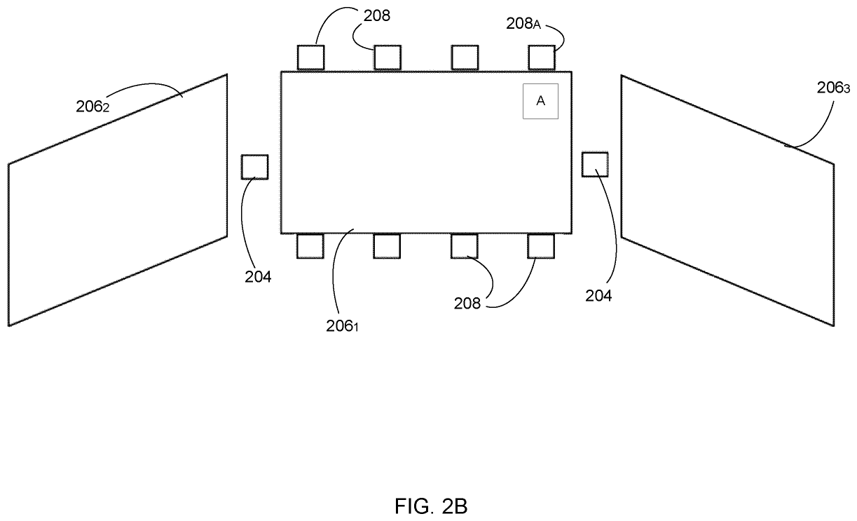

FIG. 2A shows a broadcast studio 200 arranged for recording a live event. One or more performers (e.g., an artist, musician, actor, presenter, comedian, speaker, or other entertainer, not shown) performing on a scene 202 are recorded in real-time by a recording system comprising a plurality of cameras 204 arranged at different locations in the broadcast studio 200. Several screens 206₁, 206₂, and 206₃ (also shown in FIG. 2B) visible by the performer are configured for rendering the live performance as recorded, as well as the audience's reaction to the performance, as obtained from feeds (e.g., webcam feeds) generated by the client devices 104. It should be understood that, while three (3) screens 206₁, 206₂, and 206₃ are depicted in FIG. 2A and FIG. 2B, this is for illustrative purposes only and the broadcast studio 200 may comprise any other number of screens. It should also be understood that the configuration parameters (e.g., number, positioning, resolution, and the like) of the cameras 204 and screens 206₁, 206₂, 206₃ may vary depending on the configuration of the broadcast studio 200 and of the system 100. For example, it may be desirable for the cameras 204 and/or screens 206₁, 206₂, and 206₃ to provide multiple viewing angles in two-dimensions (2D), three-dimensions (3D), augmented reality (AR), virtual reality (VR), or the like.

A number of users watching the live event may be featured (e.g., have their webcam feeds displayed) on the screens 206₁, 206₂, and 206₃. In one embodiment and as will be discussed further below, the users' viewing perspective of the live performance (i.e. the user's field of view within the virtual environment) is adapted in real-time, in accordance with the screen 206₁, 206₂, 206₃ on which the user is featured (and the position of the user's webcam feed on the screen 206₁, 206₂, and 206₃). For this purpose, a plurality of cameras 208 (shown in FIG. 2B) may be arranged on each screen 206₁, 206₂, and 206₃ and the system 100 is configured to broadcast to a given user (i.e. provide the given user access to) the recording (i.e. the camera feed signal) obtained from the camera 208 that is arranged on the screen 206₁, 206₂, 206₃ on which the user is featured and that is closest to the position of the user's webcam feed on the screen 206₁, 206₂, 206₃.

FIG. 2B illustrates an embodiment in which with four (4) cameras 208 are provided above screen 206₁ and four (4) cameras 208 are provided below screen 206₁. This is for illustrative purposes only and it should be understood that the number and location of the cameras 208 may vary. Also, while FIG. 2B illustrates cameras 208 provided on screen 206₁ only, this is for sake of clarity and it should be understood that each screen 206₁, 206₂, and 206₃ may be provided with cameras 208. It should also be understood that, in some embodiments, additional cameras 208 may be attached to the sides of each screen 206₁, 206₂, and 206₃. Other configurations may apply.

Referring back to FIG. 1 in addition to FIG. 2A and FIG. 2B, in one embodiment, the system 100 further comprises a switcher unit 118, an encoder system 120, and one or more streaming servers 122, one or more of which may be controlled at the content provider 108 or at the system level. The switcher unit 118 serves as a link between the broadcast studio 200 and the system 100. In one embodiment, the switcher unit 118 may be provided at the content provider 108. The switcher unit 118 may comprise one or more switches, which may include, but are not limited to, a Broadcast Pix™ switcher or any other suitable switch. The switcher unit 118 may enable an administrator to control the scenes to be broadcast by the content provider 108 to the client devices 104. For this purpose, in one embodiment, the switcher unit 118 may comprise a first switch (not shown) configured to switch between the cameras 204, 208 recording the live event. The first switch of the switcher unit 118 may also be configured to adjust the angles of view of the cameras 204, 208. The switcher unit 118 then outputs a stream.

In one embodiment, the system 100 enables users to have different views of the live event (also referred to as viewing perspectives or fields of view) depending on their preferences. A user may indeed be given the option to select a desired view of the scene 202. The selection may be made by the user interacting with control elements (e.g., selectable buttons) associated with the GUI presented on their device 104, using the one or more interface devices associated with their device 104. For example, the user may use the touchscreen associated with their device 104 to select between a default field of view (e.g., a viewing angle from the user's current location within the virtual venue, namely the screen 206₁, 206₂, 206₃ on which the user is featured and the position of the user's webcam feed on the screen 206₁, 206₂, 206₃), a view from the back of the virtual venue, and a view taken from different angles within the virtual venue. The first switch is then configured to switch between the cameras 204, 208 and adjust the angles of view of the cameras 204, 208 as a function of the users' selection.

In one embodiment and as will be discussed further below, a limited number (e.g., 100) of client devices 104 is selected out of the total number (e.g., 20,000) of attendees of the live event to be featured live (e.g., become webcam contributors by having their webcam feeds displayed) on the screens 206₁, 206₂, and 206₃. The switcher unit 118 may therefore comprise a second switch (not shown) configured to determine the position of the webcam feeds (associated with the limited number of client devices 104 selected to be featured live) on the screens 206₁, 206₂, and 206₃. For example, the second switch of the switcher unit 118 may determine that a given webcam feed is to be displayed in the upper right corner (location A in FIG. 2B) of screen 206₁. The first switch of the switcher unit 118 may then be configured to determine that, among the cameras 208, a given camera 208_{A} is the closest to the webcam feed's position A on screen 206₁. The first switch may then cause the recording (i.e. the camera feed signal) from camera 208_{A} to be broadcast to the client device 104 associated with the given webcam feed that is being featured in position A. It should be understood that camera feed signals from other cameras 208 may also be broadcast to the client device 104. In addition, for each client device 104 whose webcam feed is featured on the screens 206₁, 206₂, and 206₃ the system 100 is configured to direct the audio and video signals generated by the client device 104 at the performer performing the live event in the physical location. The audio and video signals are directed at the performer as a function of the position (e.g., location A) of the user's webcam feed on the screens 206₁, 206₂, and 206₃.

The selection of the limited number of client devices 104 and the determination of the positioning of their webcam feeds on the screens 206₁, 206₂, and 206₃ may be based on various criteria, as discussed further below. For example, the determination of the position of the webcam feeds may be made by the second switch of the switcher unit 118 based on the number of users that are to be featured live, the properties associated with their access right(s), or any other suitable criteria.

It should be understood that the functionality implemented by the switcher unit 118 may be automated, for instance using Machine Learning (ML) and/or artificial intelligence (AI) techniques. As used herein, machine learning and/or AI techniques refers to any suitable intelligent processing techniques that weight various factors to give the systems and methods described herein the ability to learn (e.g. improve performance, progressively and over time, on tasks described herein).

The stream is then sent (from the content provider 108) to the encoder system 120, which formats the stream for subsequent transmission to the client devices 104 over the network 106. For this purpose, in one embodiment, the encoder system 120 may digitize and encode the stream received from the switcher unit 118 into a data format appropriate for streaming to the client devices 104. The content can be encoded using any suitable format or technique including, but not limited to, Audio Video Interleave (AVI), Windows Media, MPEG4, Quicktime, Real Video, and ShockWave/Flash. The encoder system 120 illustratively encodes the stream at multiple bit rates to subsequently enable the streaming server(s) 122 to select the bit rate most suitable to the bandwidth of each one of the client devices 104. As will be discussed further below, in one embodiment, the encoder system 120 and the streaming server(s) 122 may be configured to weave the best user-generated content (e.g., live chat, webcam feeds, etc.) to the final stream users see upon accessing the virtual venue. The streaming server(s) 122 illustratively use a server software, such as the Wowza Media Server™ software or any other suitable software, which allows streaming of live multimedia content to multiple types of client devices as in 104 simultaneously. The streaming server(s) 122 use any suitable streaming protocol including, but not limited to Hypertext Transfer Protocol (HTTP) Live Streaming, Real Time Streaming Protocol (RTSP), and Multimedia Messaging Service (MMS), to broadcast the live multimedia content to the client devices 104 over the network 106. The system 100 may further allow for client devices 104 to have access to a recording or playback of the multimedia content after the live broadcast, e.g., for a predetermined duration such as 24 hours, one day, one week, and the like.

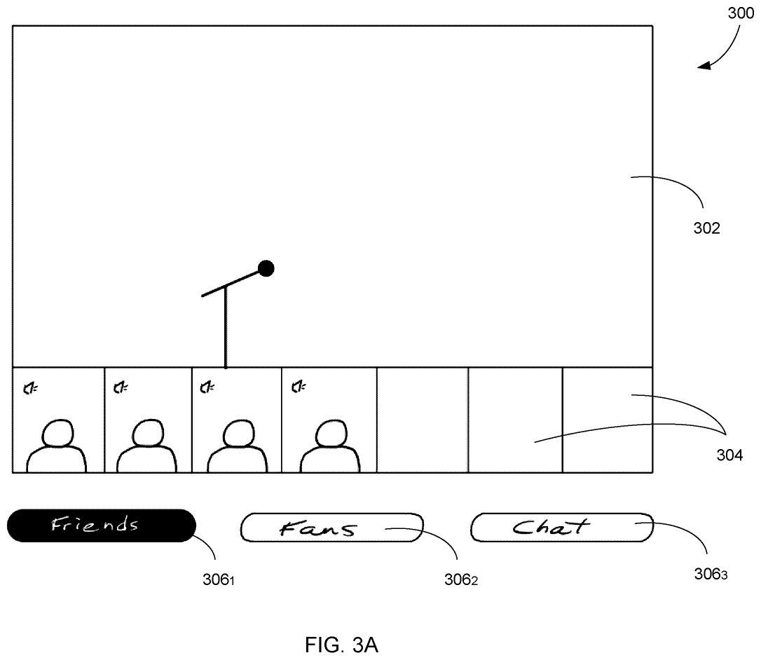

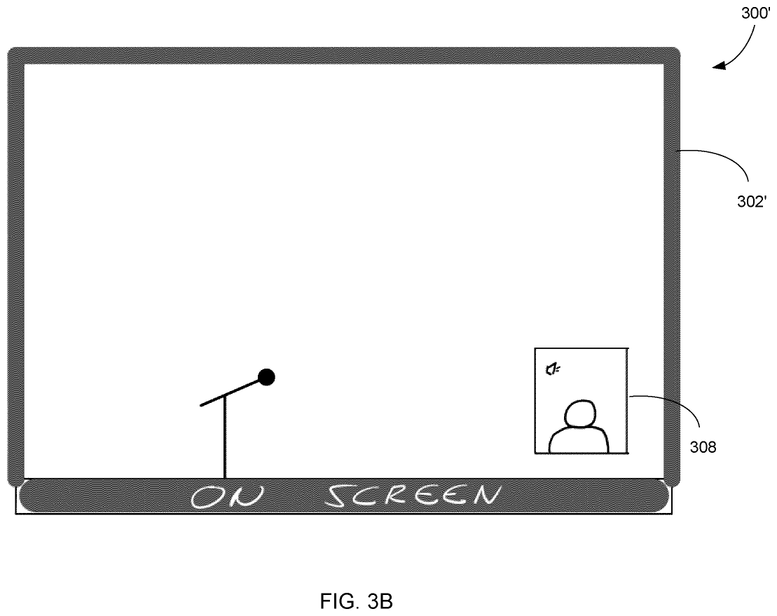

The streaming server(s) 122 may then deliver the stream for rendering on a GUI presented on each client device 104. FIG. 3A illustrates such a GUI 300, which comprises a live event frame 302, in which the live broadcast is presented. The GUI 300 further comprises a plurality of webcam frames 304 in which webcam feeds from a plurality of client devices 104 are presented. Each user of the client devices 104 may indeed become a contributor in the live broadcast (i.e. transferred to live interaction), based on a variety of selection criteria including, but not limited to, an access right purchased by the user to gain access to the virtual venue, as will be discussed further below. A client device 104 may then connect and broadcast its webcam and have its webcam feed viewed in real-time by the performer (on the screens 206₁, 206₂, and 206₃) delivering the live performance or event and by the other client devices 104 (within the webcam frames 304), simultaneously with the live event.

In one embodiment, a plurality of control elements, such as a plurality of selectable buttons, 306₁, 306₂, and 306₃ may also be part of the GUI 300 to enable the user to control the content being presented within the GUI 300. For example, in the illustrated embodiment, the button 306₁ enables the user to visualize within the webcam frames 304 which of users related to him/her (referred to herein as ‘friends’) are also viewing the live event. It should be understood that the user's friends may comprise any suitable group of individuals associated with the user, including, but not limited to, family members and friends from an online social network or social networking application. The user's friends may also be determined based on identifier(s) associated with the user's profile.

The button 306₂ enables the user to visualize within the webcam frames 304 which other specific attendees or groups of attendees (e.g., fans of a given artist or members of a given loyalty program) are also viewing the live event. The button 306₃ may be associated with a given interactive tool that may be presented on the client device 104. In the illustrated embodiment, the button 306₃ is associated with a chat box that enables the user to communicate with other attendees of the live event (i.e. users of the system 100) in real-time. Other embodiments may apply.

It should be understood that the position, shape, and size of the frames 302, 304 and buttons 306₁, 306₂, and 306₃ are for illustrative purposes only and may be modified. For example, a user may reduce the size of a given frame 302, 304 or button 306₁, 306₂, and 306₃ using the interface devices of his/her client device 104. Alternatively, an administrator of the system 100 may control the layout of the GUI 300 with the frames 302, 304 and/or buttons 306₁, 306₂, and 306₃ being presented so as to automatically fit the size and shape of the screen of each client device 104. The number of the frames 302, 304 or buttons 306₁, 306₂, and 306₃ may also vary depending on the data to be presented to the users.

Among the client devices 104 that may be selected to become contributors in the live broadcast, one or more client devices 104 may be further selected to be featured live (or ‘go live’) with the performer, i.e. to have a real-time interaction therewith, as will be discussed further below. It should be understood that multiple client devices 104 may simultaneously be featured live with the performer and the users featured live may interact with each other in real-time in addition to interacting with the performer in real-time. FIG. 3B illustrates the GUI 300′ presented on a client device 104 when the user of the client device 104 is featured live. As can be seen in FIG. 3B, the GUI 300′ comprises a live event frame 302′, in which the live broadcast (i.e. the performer) is presented, and a self-portrait frame 308, in which the user can be shown interacting with the performer (e.g., having a conversation with the performer via the webcam of the client device 104) in real-time. In other words, the user may view him/herself within the self-portrait frame 308. The GUI 300′ may further comprise one or more additional frames (not shown) that display the other user(s) featured live. As previously noted, the performer sees the webcam feed of the user(s) featured live on the screens 206₁, 206₂, 206₃.

It should be understood that the screens (references 206₁, 206₂, 206₃ in FIG. 2A and FIG. 2B) may also be used to showcase a user whose client device 104 is selected to go live with the performer. It should also be understood that users may be given the option of accepting or refusing, through the GUI 300 or 300′, to become webcam contributors or have a real-time interaction with the performer. For this purpose, the system 100 may be configured to generate and transmit invitations to the limited number of client devices 104 selected to be featured live. The invitations may be transmitted using any suitable communication means (e.g., instant push notifications sent via the network 106, Email, Short Message Service (SMS), MMS, instant messaging (IM), or the like) and rendered on the client devices 104 through the GUI 300 (e.g., as a pop-up window, message, or other suitable icon). Each user may then accept or decline the invitation. In one embodiment, only users who have accepted the invitation (i.e. for which data indicative of acceptance of the invitation is received by the system 100) become webcam contributors or have a real-time interaction with the performer.

Referring back to FIG. 1, as will be discussed further below, access to the virtual venue and to the live content or broadcast is controlled by means of an access right, such as any suitable proof of electronic purchase, which indicates that a holder of the access right has paid for access to the live multimedia content. In some embodiments, the capacity of the virtual venue may indeed be limited to a given number of client devices 104. In other embodiments, the capacity is not limited. As will be discussed further below, each access right is also used to manage in real-time the content viewed by the holder of the access right. For example, the content seen by a given user (e.g., camera angles of view, interactive tools presented within the GUI 300 of FIG. 3A) may vary based on a variety of selection criteria including, but not limited to, the access right purchased by the user. As used herein, the term ‘access right’ therefore refers to the right acquired by a user to have access to the virtual venue and view the live multimedia content within the virtual venue. In one embodiment, the access right corresponds to a proof of purchase that is associated with a unique profile of the user, as will be discussed further below. A category may be associated with each access right, the category indicating any restrictions that may apply to the access right. In one embodiment, the access right is a unique encrypted token that may be transferred or sold to another user. As used herein, the term ‘token’ refers to a software object that represents the right of a user to access the virtual venue and view the live multimedia content. The token is composed of various fields which contain information uniquely identifying the user and which encapsulate the user's credentials (e.g., properties associated with the user's profile) for accessing the virtual venue and viewing the live multimedia content.

In one embodiment, in order to access the virtual venue and view the live multimedia content being broadcast by the content provider 108, the system 100 requires users to first log in or otherwise gain authorized access to the system 100 through the use of a unique identifier. For this purpose, users illustratively register with the system 100 by completing an application using their client device 104, thereby creating a unique profile or account that may be stored in a memory 112 and/or databases 116. This may be done by accessing a website, mobile application, or other suitable access means associated with the system 100, using the client device 104. Once registration is complete, each user is illustratively provided with a unique identifier (such as an email address, a username, and/or a password, associated with his/her profile) that may be encrypted using any suitable encryption method. It should be understood that, in some embodiments, the user's identifier may be associated with an online social network or social networking application (e.g. Facebook™, Google+™, Twitter™ or the like) to which the user has subscribed.

The system 100 may then be accessed by the client device 104 upon the user identifying him/herself via the unique identifier. It should be understood that the system 100 may be accessed by multiple users simultaneously. In one embodiment, access to the system 100 may be effected by the user logging on to the website with the identifier, accessing a mobile application, using an authentication technique such as facial recognition, and/or using any other suitable access means. The identifier may then be used to verify the identity of the user upon the user attempting to access the system 100. For example, the unique identifier may be compared to a government database or another source of data used for identification purposes. In some embodiments, the unique identifier is a mobile phone number that is compared to a list of authorized and/or unauthorized mobile phone numbers, for security purposes. Other security measures may also be applied to verify the identity of the user.

In one embodiment, various levels of access rights may be provided to the users and some users may be prevented from having access to a given content on the basis of their profile information. For example, users below the legal age may not be allowed access to mature content. In one embodiment, once access to the system 100 has been granted, the user may acquire (e.g., through a bidding procedure, random selection from the received user requests, or other suitable mechanism as described herein) access right(s) to access the virtual venue and view the live broadcast. Once the access right(s) have been acquired, the application launched on the user's client device 104 creates a GUI (300 in FIG. 3A or 300′ in FIG. 3B) and presents thereon the media content associated with the live broadcast. In some embodiments, the live broadcast may be accessed on a pay-per view basis. Monthly subscription may also apply. Users may also be allowed to pay a price of their choosing before, during, or after the live broadcast, as described elsewhere in this document.

In some embodiments, selected multimedia content (e.g., a bonus segment of the live event) may be made available to some users in accordance with the amount paid to acquire their access right(s). In other words, access to the selected content may depend on the properties associated with the users' access right(s). For example, some users may have paid a higher price to purchase their access right(s) compared to other users. The users having paid more for their access right(s) may then be allowed to view the selected content while the remaining users may not (e.g., the broadcast is stopped after a pre-determined time period, prior to the selected multimedia content being broadcast).

In one embodiment, an electronic wallet containing payment information, digital coupons, a history of used access rights, active access rights for future events, and other relevant information, may be associated with each user profile. The electronic wallet may also comprise a photograph of the user that can be used, for instance, for facial recognition purposes. The system 100 may also associate the user's profile with a unique encrypted token that is temporary and representative of a proof of purchase (e.g. of an access right purchased by the user). The token may contain information (or properties), such as the price value associated with the purchased access right as well as other relevant information identifying the virtual venue and/or event. The properties associated with each token then determine the content that is available for access. It should be understood that, since a given user may purchase multiple access rights, a given user profile may hold multiple tokens, e.g. having different price values.

Still referring to FIG. 1, the server 102 may comprise a series of servers corresponding to a web server, an application server, and a database server. These servers are all represented by server 102 in FIG. 1. The server 102 may comprise, amongst other things, a processor 110 coupled to a memory 112 and having a plurality of applications 114a, , 114n running thereon. The processor 110 may access the memory 112 to retrieve data. The processor 110 may be any device that can perform operations on data. Examples are a central processing unit (CPU), a microprocessor, and a front-end processor. The applications 114a, . . . , 114n are coupled to the processor 110 and configured to perform various tasks as explained below in more detail. It should be understood that while the applications 114a, . . . , 114n presented herein are illustrated and described as separate entities, they may be combined or separated in a variety of ways. It should be understood that an operating system (not shown) may be used as an intermediary between the processor 110 and the applications 114a, . . . , 114n.

The memory 112 accessible by the processor 110 may receive and store data. The memory 112 may be a main memory, such as a high speed Random Access Memory (RAM), or an auxiliary storage unit, such as a hard disk or flash memory. The memory 112 may be any other type of memory, such as a Read-Only Memory (ROM), Erasable Programmable Read-Only Memory (EPROM), or optical storage media such as a videodisc and a compact disc. Also, although the system 100 is described herein as comprising the processor 110 having the applications 114a, , 114n running thereon, it should be understood that cloud computing may also be used. As such, the memory 112 may comprise cloud storage.

One or more databases 116 may be integrated directly into the memory 112 or may be provided separately therefrom and remotely from the server 102 (as illustrated). In the case of a remote access to the databases 116, access may occur via any type of network 106, as indicated above. The databases 116 described herein may be provided as collections of data or information organized for rapid search and retrieval by a computer. The databases 116 may be structured to facilitate storage, retrieval, modification, and deletion of data in conjunction with various data-processing operations. The databases 116 may consist of a file or sets of files that can be broken down into records, each of which consists of one or more fields. Database information may be retrieved through queries using keywords and sorting commands, in order to rapidly search, rearrange, group, and select the field. The databases 116 may be any organization of data on a data storage medium, such as one or more servers. As discussed above, the system 100 may use cloud computing and it should therefore be understood that the databases 116 may comprise cloud storage.

In one embodiment, the databases 116 are secure web servers and Hypertext Transport Protocol Secure (HTTPS) capable of supporting Transport Layer Security (TLS), which is a protocol used for access to the data. Communications to and from the secure web servers may be secured using Secure Sockets Layer (SSL). Identity verification of a user may be performed using usernames and passwords for all users. Various levels of access authorizations may be provided to multiple levels of users.

Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

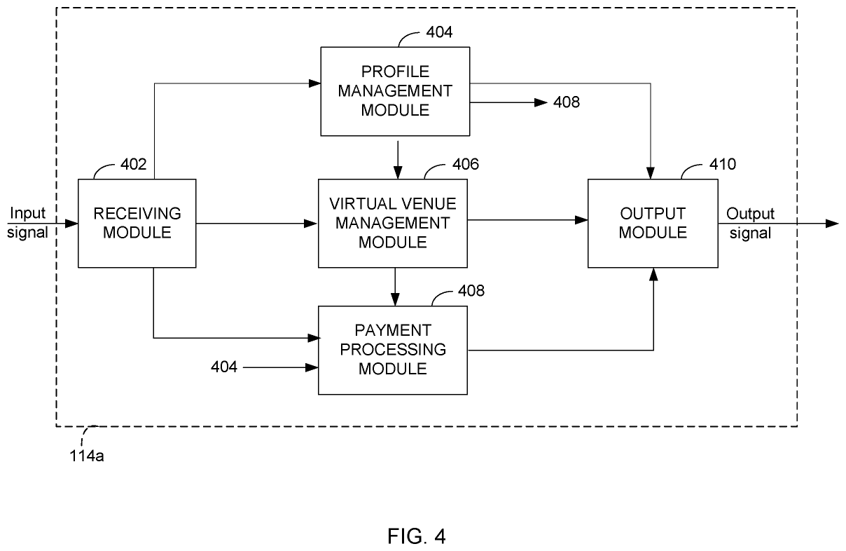

FIG. 4 is an exemplary embodiment of an application 114a running on the processor 110. The application 114a illustratively comprises a receiving module 402, a profile management module 404, a virtual venue management module 406, a payment processing module 408, and an output module 410.

The receiving module 402 illustratively receives one or more input signals from the one or more client device(s) 104 and/or the content provider 108. The input signals received from the content provider 108 may comprise the audio and video signals (i.e. camera feed signals) recorded for broadcast to the client devices 104, as well as signals (e.g., webcam feed sisnglas) received from the client devices 104. The input signals received from the content provider 108 may also comprise pricing information for the access rights, e.g. a minimum price value for each category of access right, as well as other relevant information, including, but not limited to, standing access right details, inventory data (e.g. information about available access rights and their associated category), and the like.

The input signal(s) received from each client device 104 may comprise data uniquely identifying the user, e.g. the user's identifier associated with his/her account in the system 100. The user identifier may indeed be received upon the user attempting to gain access to the system 100. The user identifier may then be sent by the receiving module 402 to the profile management module 404 for authenticating the user prior to providing the user access to functionalities of the system 100. The profile management module 404 may, upon receiving the user identifier, retrieve from the memory 112 and/or databases 116 a stored user identifier associated with the user's account. The profile management module 404 may be configured to determine whether any restrictions on the user or on the user's access to the system 100 exist. The profile management module 404 may then compare the retrieved user identifier and the user identifier received from the receiving module 402. If both identifiers match, the profile management module 404 successfully authenticates the user and may generate a message to that effect. Otherwise, if the identifiers do not match, the profile management module 404 determines that the user attempting to access the system 100 should not be authorized to do so and a message to that effect may be generated. The message output by the profile management module 404 may then be sent to the output module 410 for rendering on a suitable output device, e.g. a screen, provided with the client device 104. The output module 412 may transmit data to the client device 104 through instant push notifications sent via the network 106. Email, SMS, MMS, IM, or other suitable communication means known to those skilled in the art may also apply.

Upon a user being allowed access to the system 100, the input data received at the receiving module 402 from each client device 104 may also comprise request data, which is received in real-time and indicates that one or more users are requesting to be granted access to the virtual venue (i.e. access to the live multimedia content). The request data may comprise an indication of the number of access rights requested by users. The request data may contain user-specific criteria that identifies access right category(ies) for which each user wishes to purchase access right(s) as well as information indicating the price that each user is willing to pay to acquire the access right(s) in accordance with the criteria they entered. The request data is then sent to the virtual venue management module 406, which is configured to grant (or deny) users access rights based on their requests, the access rights once acquired enabling the users to gain access to the virtual venue and view the live multimedia content, as will be discussed further below.

It should be understood that access rights may be bundled. For example, a bundle of three (3) access rights to multiple live events may be purchased for a fixed price (e.g., $24,99). It should also be understood that, in some embodiments, users may acquire access right(s) by paying (before, during, or after the live event) a price of their choosing. This may be the case, for instance, of live benefit (or charity) performances, which may be held for charitable purposes and broadcast by the content provider 108. In some embodiments, the event may be free for all users to attend upon accessing the virtual venue. Users may however be encouraged to make a monetary donation (of a monetary amount of their choosing). In other embodiments, a minimum price (i.e. donation) may be required of users to attend the event (i.e. to access the virtual venue and view the multimedia content).

The request data may be associated with payment data (e.g. credit card information, financial account numbers, account debit authorizations, electronic funds transfer information, and other relevant payment information) that may also be received at the receiving module 402. When payment data is received, the receiving module 402 transmits the payment data to the payment processing module 408, which processes the payment data to proceed with the payment. In particular, the payment processing module 408 may charge a credit card or financial account of the user as per the payment data. Payment data may alternatively be received directly from the profile management module 404. This may for example be the case when the user chooses to use stored information, e.g. credit card information, provided in his/her profile to proceed with the payment rather than entering his/her payment information. The user may also choose to use a stored payment value associated with his/her profile. As such, the payment information may be retrieved from the user's profile and sent directly to the payment processing module 408 upon the user purchasing access right(s). The output of the payment processing module 408 (e.g. payment completed) may then be sent to the output module 410, which generates an output signal comprising data to be rendered on an interface, e.g. a screen, of the client's device 104.

In one embodiment, users may be allocated or granted access rights in the manner described in co-pending U.S. patent application Ser. No. 15/575,770 entitled SYSTEM AND METHOD FOR MANAGING EVENT ACCESS RIGHTS and in Patent Cooperation Treaty (PCT) Application number PCT/CA2019/051418 entitled SYSTEM AND METHOD FOR EVENT ADMISSION, and which the entire disclosures thereof are hereby incorporated by reference. In one embodiment, a real-time bidding procedure during which users place bids to acquire the access rights may apply. As used herein, the term ‘purchase’ therefore refers to a procedure (including, but not limited to, a bidding procedure) during which access rights can be acquired by users in exchange for payment of a given monetary amount. In some embodiments, only users that have been authenticated by (and are accordingly registered with) the system 100 in the manner described herein above may be allowed to place bids. In other embodiments, all users, registered or not, are allowed to place bids. As such, the request data obtained at the receiving module 402 may comprise bidding data indicative of the received bids and the payment processing module 408 may proceed with pre-authorized payment followed by processing payment (e.g., by charging a credit card, financial account, or the like, of the user) for successful (or winning) bids only (rather than for all users requesting access to the virtual venue).

The virtual venue management module 406 may then grant to successful bidders an access right that provides them access to the virtual venue for viewing the multimedia content. For this purpose, the virtual venue management module 406 activates the unique encrypted token associated with the profile of each winning bidder. Activation of the token indicates that the user's bid has been recognized as valid. Each token is activated in accordance with restrictions related to the user's bidding. For example, successful bids of higher monetary value (e.g. above 500 dollars) may enable the users having placed the bids to view content of higher audio and video quality, better camera angle, view content for a predetermined (e.g., longer) duration, become webcam contributors and/or be featured live and interact in real-time with the performer (as described herein with reference to FIG. 3A and FIG. 3B), compared to successful bids of lower monetary value. Different prices may also be associated with different content viewing quality or resolution including, but not limited to, standard definition (SD), high definition (HD), 4K, and 8K. As such, different users may pay different prices (i.e. place bids of different monetary value) depending on the desired viewing quality.

The virtual venue management module 406 then authorizes successful or winning bidders to gain access to the virtual venue to view the live content in accordance with the restrictions associated with their access rights. In one embodiment, the authorization may be provided by issuing a unique access code to winning bidders, the access code allowing the bidders to access the virtual venue. In another embodiment, no access code may be provided and information (e.g. token activation information) from each user's profile may be retrieved to confirm that the user attempting to access the virtual venue is indeed among the successful bidders and is therefore authorized access to the virtual venue to view the live broadcast.

The virtual venue management module 406 may further manage the content viewed by the users in real-time, in accordance with the restrictions associated with the purchased access rights. In one embodiment, this is achieved by controlling the switcher unit 118, encoder system 120, and streaming server(s) 122 of FIG. 1 accordingly. As discussed above with reference to FIG. 2A and FIG. 2B, the performer is illustratively facing cameras 204, 208 and multiple screens 206₁, 206₂, 206₃ on which a number of users watching the live event are featured. In order to have the users' reaction synchronized with the live performance broadcast by the content provider (reference 108 in FIG. 1), the virtual venue management module 406 causes the streaming server(s) 122 (reference in FIG. 1) to adjust the timing and video quality of the broadcast in real time. For this purpose, the virtual venue management module 406 is configured to receive, via the receiving module 402 and from the content provider 108, the audio and video signals recorded at the studio (reference 200 in FIG. 2A). The virtual venue management module 406 also receives the webcam feed signals from the client devices 104 that have been authenticated with the system 100. The received signals are then electronically timestamped (i.e. assigned a sequence of characters or encoded information identifying the time of day when the signals are received). Given the large audience, the virtual venue management 406 causes the streaming server(s) 122 (reference in FIG. 1) to use the timestamps to introduce into the signals a predetermined time delay (e.g., an artificial thirty (30) seconds buffer) prior to causing the streaming server(s) 122 to generate and transmit the stream having the delay to the client devices 104. This results in the introduction of a delay between the moment the live event is captured at the studio and the moment the stream is delivered to the client devices 104. In this manner, the viewing quality of the stream delivered by the streaming server(s) 122 is synchronized among all client devices 104, based on the technical specifications (e.g., bandwidth, connectivity speed) of the client devices 104.

As discussed above with reference to FIG. 3A, the virtual venue management module 406 is further configured to prioritize users in real-time according to their access rights. The virtual venue management module 406 can indeed select, based on a variety of selection criteria, a number of users that will broadcast their webcam feeds to contribute to the live event (i.e. select a subset of the client devices 104 that will be prioritized for live interaction during the broadcast). In particular, given the large audience (e.g., thousands of attendees) and the limited number (e.g., 50 to 100) of screens (references 206₁, 206₂, 206₃ in FIG. 2A and FIG. 2B) that are visible to the performer at any given time during the live event, it is desirable to select a limited number of client devices 104 that can become webcam contributors. The subset of client devices 104 is selected in accordance with the number of screens as in 206₁, 206₂, 206₃.

The virtual venue management module 406 may be configured to select the subset of client devices 104 based on a plurality of selection criteria. For this purpose, the system 100 tracks every user currently watching the broadcast (e.g., within the last five (5) seconds or over any other suitable period in time) on their client device 104. The virtual venue management module 406 then uses the profile information of each user along with the properties associated with their access right(s) to select users (and accordingly the subset of client devices 104) to be featured live. For example, the virtual venue management module 406 may filter users based on parameters including, but not limited to, an age, gender, location, and amount paid to purchase the access right(s).

In one embodiment, the number of devices 104 in the subset corresponds to the number of screens as in 206₁, 206₂, 206₃, such that the webcam feed of one device 104 is featured on each screen. In another embodiment, more devices 104 than the number of screens as in 206₁, 206₂, 206₃ are selected to form the subset, such that the webcam feeds of multiple users are featured on any given screen. For example, if a total of 10,000 attendees have been granted access to the virtual venue to view the live event and a total of ten (10) screens as in 206₁, 206₂, 206₃ are installed in the broadcast studio 200, the virtual venue management module 406 may select one hundred (100) users to form the subset of client devices 104, such that the webcam feeds of ten (10) users are presented on each screen as in 206₁, 206₂, 206₃ for viewing by the performer. It should be understood that, in one embodiment, the subsets of client devices 104 are rotated during the live event such that several client devices 104 (and accordingly several users) have the opportunity to become webcam contributors.

In one embodiment, the virtual venue management module 406 selects the subset of client devices 104 (i.e. the prioritized client devices 104) randomly. This may be the case where all users have purchased access rights at equal monetary amounts. In another embodiment, the virtual venue management module 406 selects the subset of client devices 104 based on manual input (e.g., from the content provider 108). In yet another embodiment, the content viewed by the users (i.e. winning bidders) is managed in real-time based on the monetary value and/or restrictions associated with each bid. In this case, the virtual venue management module 406 may select the subset of client devices 104 according to the monetary value associated with the users' purchased access rights. For example, successful bids of higher monetary value (e.g. above 500 dollars) may allow the users (i.e. higher priority users) having placed the bids to become webcam contributors, unlike successful bids of lower monetary value (e.g. below 500 dollars) associated with lower priority users.

In yet another embodiment, the virtual venue management module 406 implements ML and/or AI techniques to select webcam feeds to contribute to the live broadcast, based on the quality of the user-generated content. For example, the ML and/or AI techniques may be used to filter out webcam feeds of lower audio and video quality among the webcam feeds received form the client devices 104, and accordingly select higher quality webcam feeds to form the subset of client devices 104. The ML and/or AI techniques may also be used to analyze the webcam feeds and select webcam feeds in which users exhibit a behaviour identified as desirable (e.g., display enthusiasm and show engagement for the live event, perform popular or impressive dance moves, or the like). Similarly, the ML and/or AI techniques may be used to reject webcam feeds in which users exhibit a behaviour identified as undesirable (e.g., lack of enthusiasm or inappropriate behaviour). For example, the virtual venue management module 406 is configured to remove users that exhibit undesirable behaviour from the live broadcast and to return these users into the stream having the delay so the live broadcast is not negatively impacted by the undesirable actions of these users. The virtual venue management module 406 may therefore be configured to weave the best user-generated content (e.g., web cam feeds, live chat, etc.) to the final stream seen by users.

The virtual venue management module 406 may then cause the webcam feeds of the selected subset of client devices 104 to be presented (on the screens 206₁, 206₂, 206₃ of FIGS. 2A and 2B and within the GUI 300 of FIG. 3A) concurrently with the live broadcast. For this purpose, the subset of client devices 104 is transferred to a fully live interaction with the performer, where the input signals received from the subset of client devices 104 can be indexed alongside the stream, for consumption through the streaming server(s) (reference 122 in FIG. 1). When the client devices 104 are transferred to the live interaction, the users of the subset of client devices 104 skip forward in time in the live broadcast by the predetermined delay by virtue of being transferred from the stream having the delay to the stream, in which the delay is removed. If the virtual venue management module 406 selects another subset of client devices 104 to become webcam contributors (or after a predetermined time period has elapsed), the previous subset of client devices 104 is transferred back to the stream having the delay and the users of the previous subset of client devices 104 are caused to re-watch the live broadcast for the duration of the delay that was skipped. For example, the users are caused to view the last thirty (30) seconds during which they were webcam contributors.

In one embodiment, the webcam feeds are real-time feeds (i.e. to which no broadcasting delay is introduced) overlaid on (or otherwise combined with) the stream. For example, a user contributing their webcam to the live broadcast may visualize and interact in real-time (via the webcam frames 304 of FIG. 3A) with his/her friends that are also viewing the live event displayed within the live event frame (reference 302 of FIG. 3A). In other words, users of the subset of client devices 104 may interact with one another in real-time. In another embodiment, a user that was not selected to become a webcam contributor (or did not turn his webcam, video recorder, or voice recorder on) may view (within the webcam frames 304) the webcam contributors selected by the virtual venue management module 406, with the webcam feeds of these contributors being delayed in order to synchronize the webcam feeds with the stream viewed by the user (within the live event frame 302). It should therefore be understood that the broadcasting delay may or may not be introduced into the webcam feeds presented within the webcam frames 304. It should also be understood that, while it is described herein that webcam contributors may in some embodiments be selected to have their webcam feeds be weaved (i.e. combined) in real-time with the live broadcast, users may still interact with others (e.g., their friends) using their webcam even if the users are not selected to become webcam contributors.

As discussed above with reference to FIG. 3B, when a group of users is selected to become webcam contributors, it is possible for the content provider 108 to select one or more users within the group and have them interact with the performer in real time. In this manner, bi-directional communication may be established (through the client device 104 and the screens 206₁, 206₂, and 206₃) between the selected user(s) and the performer. The selected user(s) may be chosen by the virtual venue management module 406 among the subset of client devices 104, based on a number of selection criteria as described herein above.

In one embodiment, the virtual venue management module 406 may be configured to generate and transmit to selected client devices 104 invitations to be featured live and to notify the users (e.g., ping the client devices 104) of any changes to the status of their invitation to be featured live. When the subset of client devices 104 featured live is to be rotated such that a new subset of client devices 104 is given the opportunity to become webcam contributors, the virtual venue management module 406 causes an interruption in the broadcast being watched by users of the new subset of client devices 104 and transmits to the new subset of client devices 104 an invitation to be featured live. As previously noted, the users of the new subset of client devices 104 can respond (e.g., via the GUI 300) by accepting or declining the invitation.

When users (i.e. client devices 104) are to be rotated for being featured live, the virtual venue management 406 is configured to ensure that users rotated (i.e. featured live) onto the screens 206₁, 206₂, 206₃ are only allowed to consume (i.e. view) multimedia content they have access to. For this purpose, the virtual venue management module 406 is configured to control when specific segments (e.g., video segments) of the broadcast start and end. When a segment is marked by the virtual venue management module 406 as finished, the virtual venue management module 406 causes the broadcast displayed on the client devices 104 of users who purchased access to only that segment to go into replay mode. The virtual venue management module 406 further causes the users to lose access to further segments of the broadcast. As a result, any user who is currently actively interacting with the artist will be automatically removed from the live interaction and returned into the stream having the delay (that was skipped by virtue of being transferred to the live interaction). The virtual venue management module 406 will allow other users who have access to the next segment(s) of the stream to continue interacting with the artist and remain featured on the screens 206₁, 206₂, 206₃. It should be understood that the virtual venue management module 406 may be configured to automatically invite as many new users with access to the next segment(s) of the stream as needed to fill the spaces left by the users that got removed from the stream in which the delay is removed.

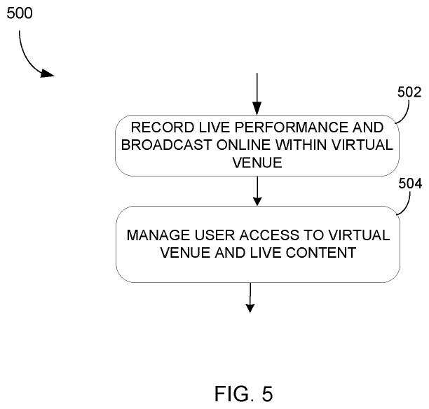

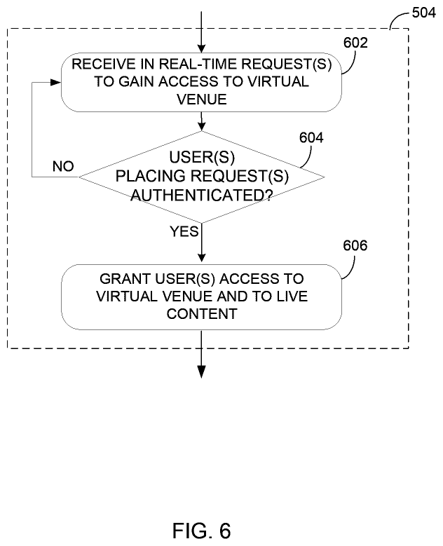

Referring now to FIG. 5, a method 500 for streaming live multimedia content to an audience in a virtual venue, in accordance with one embodiment, will now be described. The method 500 illustratively comprises, at step 502, recording a live performance and broadcasting the live performance online within a virtual venue. At step 504, access to the virtual venue and to the live content is managed in real-time. As shown in FIG. 6, step 504 comprises receiving in real-time request(s) from user(s) to gain access to the virtual venue (step 602). The next step 604 is then to assess whether the user(s) having placed the request(s) are authenticated user(s). As used herein, the term ‘authenticated users’ refers to users that have been authenticated (e.g., registered through their unique identifier as discussed herein above) with the system 100 of FIG. 1 for the purpose of providing them access to functionalities of the system 100. If it is determined at step 604 that the user(s) are not authenticated, the method 500 may flow back to step 602. Otherwise, if it is determined at step 604 that the user(s) are authenticated user(s), the next step 606 is to grant, to a number of user(s) among the authenticated user(s), access to the virtual venue and to the live content. In one embodiment, access to the virtual venue is granted based on purchased access rights (based on mechanisms for granting or allocating access rights described elsewhere in this document), such that step 606 may comprise processing payment for the authenticated user(s), in the manner described herein above. In another embodiment, access to the virtual venue is granted randomly, such that a random number of user(s) among the authenticated user(s) is granted access to the live content. In yet another embodiment, all authenticated user(s) may be granted access to the virtual venue. Other embodiments, including, but not limited to, the other methods for granting access to the virtual venue described herein, may apply.

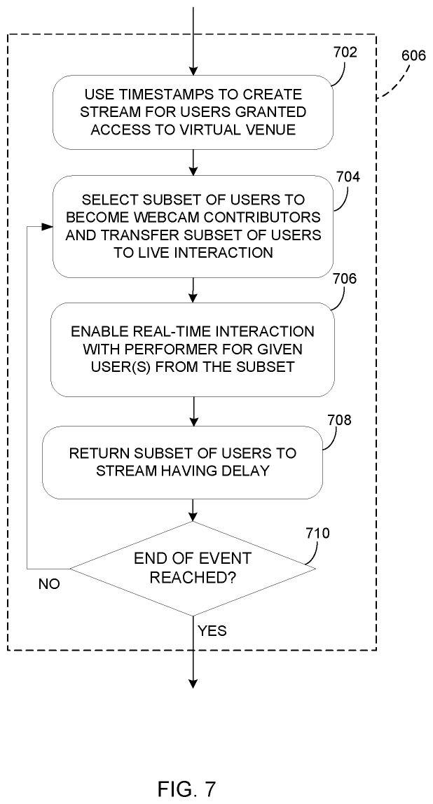

As illustrated in FIG. 7, step 606 illustratively comprises using timestamps to create a stream for users granted access to the virtual venue (step 702). As described herein above, a pre-determined delay is introduced into the stream to allow for synchronization of viewing quality among all users viewing the live content within the virtual venue (e.g., for synchronization of the audience's reaction with the live event being streamed). The next step 704 is then to select a subset of users to become webcam contributors and transferring the subset of users to a live interaction with the performers where their inputs (e.g., webcam feed signals) can be indexed alongside the stream in the manner described herein above. In particular, the delay is removed for the subset of users and their webcam feed signals are rendered at the physical location (e.g., on screens 206₁, 206₂, and 206₃) . Real-time interaction with the performer may also be enabled at step 706 for given user(s) from the subset.

The selection made at steps 704 and 706 may be random or based on a number of selection criteria including, but not limited to, the access right purchased by each user to gain access to the virtual venue and the quality of the user-generated content, as discussed herein above. It should be understood that the selection may also be based on manual input (e.g., from the content provider 108). The selection may also use AI/ML techniques based on the inputs received from users having their webcams turned on, as described herein above. It should also be understood that users may be given the option of accepting or refusing the selection made at steps 704 and 706, i.e. accepting or refusing to become webcam contributors or having real-time interaction with the performer. After a predetermined time period, the subset of users is then returned to the stream having the delay (step 708). The next step 710 may then be to assess whether the end of the live event has been reached. If this is the case, the method 500 may end. Otherwise, the method 500 may return to step 704 to select another subset of users to become webcam contributors.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment.

It should be noted that the present invention can be carried out as a method, can be embodied in a system, and/or on a computer readable medium. The embodiments of the invention described above are intended to be exemplary only. The scope of the invention is therefore intended to be limited solely by the scope of the appended claims.

1. A system comprising:
a memory;
a processor; and
an application stored in the memory and executable by the processor for:
receiving over a communication network, from a plurality of devices, one or more requests to access live multimedia content;
providing, based on the one or more requests, a first subset of the plurality of devices access, over the communication network, to a stream comprising the live multimedia content, the stream generated by a plurality of cameras capturing a live event occurring in a physical location; and
iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.

2. The system of claim 1, wherein, for each device in the second subset of devices, the application is executable by the processor for causing audio and video signals generated by the device to be directed at a performer performing the live event in the physical location, the audio and video signals directed at the performer as a function of the given position.

3. The system of claim 1, wherein the application is executable by the processor for selecting at least one device among the second subset of devices, and for enabling, through the at least one device and the at least one screen, real-time interaction between a user of the at least one device and a performer performing the live event in the physical location.

4. The system of claim 1, wherein the application is executable by the processor for providing the second subset of devices access, over the communication network, to camera feed signals from other ones of the plurality of cameras.

5. The system of claim 1, wherein the application is executable by the processor for selecting, among the first subset of devices, a new subset of devices to become the second subset of devices.

6. The system of claim 5, wherein the application is executable by the processor for selecting the new subset of devices after a predetermined time period has elapsed.

7. The system of claim 1, wherein the application is executable by the processor for receiving the one or more requests comprising receiving in real-time, during a bidding procedure, one or more bids for acquiring access to the live multimedia content based on user-specific criteria, and for selecting the first subset of devices and the second subset of devices and providing access to the stream based on the one or more bids.

8. The system of claim 1, wherein the application is executable by the processor for causing at least one streaming server to introduce a pre-determined time delay into the stream and broadcast the stream having the pre-determined time delay to the first subset of devices over the communication network, and for causing the at least one streaming server to remove the pre-determined time delay from the stream and broadcast the stream in which the pre-determined time delay is removed to the second subset of devices over the communication network.

9. The system of claim 1, wherein the application is executable by the processor for causing the live multimedia content to be rendered on a graphical user interface presented on each device of the first subset of devices and of the second subset of devices, and for causing the webcam feed signal of each device in the second subset of devices to be rendered on the graphical user interface.

10. The system of claim 1, wherein the application is executable by the processor for transmitting to each device in the second subset of devices an invitation to share the webcam feed signal in real-time and for causing the webcam feed signal to be rendered at the given position on the screen and providing the second subset of devices access to the camera feed signal upon receiving an indication of acceptance of the invitation.

11. A computer-implemented method comprising, at a processor:
receiving over a communication network, from a plurality of devices, one or more requests to access live multimedia content;
providing, based on the one or more requests, a first subset of the plurality of devices access, over the communication network, to a stream comprising the live multimedia content, the stream generated by a plurality of cameras capturing a live event occurring in a physical location; and
iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.

12. The method of claim 11, further comprising, for each device in the second subset of devices, causing audio and video signals generated by the device to be directed at a performer performing the live event in the physical location, the audio and video signals directed at the performer as a function of the given position.

13. The method of claim 11, further comprising selecting at least one device among the second subset of devices, and enabling, through the at least one device and the at least one screen, real-time interaction between a user of the at least one device and a performer performing the live event in the physical location.

14. The method of claim 11, further comprising providing the second subset of devices access, over the communication network, to camera feed signals from other ones of the plurality of cameras.

15. The method of claim 11, further comprising selecting, among the first subset of devices, a new subset of devices to become the second subset of devices.

16. The method of claim 15, wherein the new subset of devices is selected after a predetermined time period has elapsed.

17. The method of claim 11, wherein receiving the one or more requests comprises receiving in real-time, during a bidding procedure, one or more bids for acquiring access to the live multimedia content based on user-specific criteria, the first subset of devices and the second subset of devices selected and access to the stream provided based on the one or more bids.

18. The method of claim 11, further comprising causing at least one streaming server to introduce a pre-determined time delay into the stream and broadcast the stream having the pre-determined time delay to the first subset of devices over the communication network, and causing the at least one streaming server to remove the pre-determined time delay from the stream and broadcast the stream in which the pre-determined time delay is removed to the second subset of devices over the communication network.

19. The method of claim 11, further comprising causing the live multimedia content to be rendered on a graphical user interface presented on each device of the first subset of devices and of the second subset of devices, and causing the webcam feed signal of each device in the second subset of devices to be rendered on the graphical user interface.

20. The method of claim 11, further comprising transmitting to each device in the second subset of devices an invitation to share the webcam feed signal in real-time and causing the webcam feed signal to be rendered at the given position on the screen and providing the second subset of devices access to the camera feed signal upon receiving an indication of acceptance of the invitation.

21. A computer readable medium having stored thereon program code executable by a processor for:
receiving over a communication network, from a plurality of devices, one or more requests to access live multimedia content;
providing, based on the one or more requests, a first subset of the plurality of devices access, over a communication network, to a stream comprising the live multimedia content, the stream generated by a plurality of cameras capturing a live event occurring in a physical location; and
iteratively selecting, among the first subset of devices, a second subset of the plurality of devices, causing a webcam feed signal of each device in the second subset of devices to be rendered, in real-time, at a given position on a screen provided at the physical location, and, as a function of the given position, providing the second subset of devices access, over the communication network, to a camera feed signal from a selected one of the plurality of cameras.
